(19) United States
(12) Patent Application Publication
(10) Pub. No.: US 2025/0340100 A1
(43) Pub. Date: Nov. 6, 2025

(54) DYNAMIC HEAT PUMP CONTROL FOR ELECTRIC VEHICLES

(71) Applicant: Rivian IP Holdings, LLC, Irvine, CA (US)

(72) Inventors: Paulo Lucena Kreppel PAES, Irvine, CA (US); Dewashish PRASHAD, Irvine, CA (US); Eric Anthony CORA, Irvine, CA (US); Clay Anton JARZOMBEK, Los Angeles, CA (US); Amr Mohamed ZEDAN, Irvine, CA (US); Aldrin Lenus SALDANHA, Irvine, CA (US); Ean Joshua HALL, Long Beach, CA (US); Zachary Kyle MOUL, Hermosa Beach, CA (US); Ajay PANEKKAD, Laguna Niguel, CA (US); Srivatsan MADHAVAN, Irvine, CA (US); Somendra Pratap SINGH, Irvine, CA (US); Sushant MORE, Irvine, CA (US); Jing HE, Novi, MI (US)

(21) Appl. No.: 19/199,227

(22) Filed: May 5, 2025

Related U.S. Application Data
(60) Provisional application No. 63/643,405, filed on May 6, 2024.

(51) Int. Cl. B60H 1/00

(52) U.S. Cl. CPC B60H 1/00921; B60H 1/00278; B60H 1/00385; B60H 1/00785; B60H 2001/00307; B60H 2001/00928

(57) ABSTRACT

A vapor compression heat transfer system includes a compressor configured to compress a refrigerant and a condenser coupled to an outlet of the compressor and configured to receive air flow from a space, the condenser including an inlet air temperature sensor and an outlet air temperature sensor. One or more electronic expansion valves (EXVs) coupled to the outlet of the condenser. One or more heat exchangers are coupled to outlets of the one or more EXVs. A controller is configured to calculate a heat load of the condenser according to current heat transfer from the condenser to the space and an amount of heat transfer calculated to change an output of the outlet air temperature sensor to a target air temperature at a target rate. The controller at least partially controls a speed of the compressor to achieve the heat load at the condenser. Feedback control is also used to control the speed of the compressor, such as based on sensed temperature of the refrigerant, air in the space, or other temperature.

### RELATED APPLICATION

This application claims the benefit of U.S. Application Ser. No. 63/643,405 filed May 6, 2024 and entitled DYNAMIC HEAT PUMP CONTROL FOR ELECTRIC VEHICLES.

### INTRODUCTION

The present disclosure relates to controlling a heat pump in a vehicle, such as a battery electric or hybrid vehicle.

### SUMMARY

The present disclosure describes an approach for controlling a vapor compression heat transfer system, such as a heat pump. In one aspect, a vapor compression heat transfer system includes a compressor configured to compress a refrigerant and a condenser coupled to an outlet of the compressor and configured to receive air flow from a space, the condenser including an inlet air temperature sensor and an outlet air temperature sensor. One or more electronic expansion valves (EXVs) are coupled to the outlet of the condenser. One or more heat exchangers are coupled to outlets of the one or more EXVs. A controller is coupled to the compressor, the one or more EXVs, the inlet air temperature sensor, and the outlet air temperature sensor. The controller is configured to calculate a heat load of the condenser according to current heat transfer from the condenser to the space and an amount of heat transfer calculated to change an output of the outlet air temperature sensor to a target air temperature at a target rate, and at least partially control a speed of the compressor to achieve the heat load at the condenser.

In another aspect, a method includes receiving, by a controller of a vapor compression heat transfer system, a target temperature. The controller receives an inlet temperature from an inlet air temperature sensor configured to sense a temperature at an air inlet of a condenser configured to exchange heat with air within a space. The controller receives an outlet temperature from an outlet air temperature sensor configured to sense a temperature at an air outlet of the condenser. The controller determines a heat load based on: (a) a current heat flow out of the condenser according to the inlet temperature and the outlet temperature and (b) a heat flow that raises the outlet temperature to the target temperature at a predefined rate. The controller selects a speed of a compressor according to the heat load, an output of the compressor being coupled to a refrigerant inlet of the condenser, an inlet of the compressor being coupled to a heat exchanger, and the heat exchanger being coupled to a refrigerant outlet of the condenser by an expansion valve. The controller invokes operation of the compressor to compress refrigerant at the selected speed.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic diagram showing components of a vapor compression heat transfer system in accordance with certain embodiments.

FIG. 4 is a schematic block diagram of components of a controller of a vapor compression heat transfer system in accordance with certain embodiments.

FIG. 5 illustrates equations for computing heat load and energy balance in accordance with certain embodiments.

FIG. 6 is a schematic block diagram of logic for determining a mass flow rate of refrigerant in accordance with certain embodiments.

FIG. 7 is a schematic block diagram of logic for selecting the speed of a compressor in accordance with certain embodiments.

FIG. 8 is a process flow diagram of a method for combining feedback and feedforward commands to control a compressor in accordance with certain embodiments.

FIG. 9 illustrates equations that may be used to control opening of an electronic expansion valve in accordance with certain embodiments.

FIG. 10 is a process flow diagram of a method for selecting a target temperature in accordance with certain embodiments.

FIG. 11A is a schematic diagram of a vapor compression heat transfer system in accordance with certain embodiments.

FIG. 11B illustrates inputs for selecting temperature targets in accordance with certain embodiments.

### DETAILED DESCRIPTION

Battery electric vehicles (BEVs) cannot rely on the heat generated by an internal combustion engine to heat the cabin of the vehicle. BEVs therefore use a resistive heater or preferably a heat pump in order to heat the cabin. Since the power used to generate heat comes from the battery, any energy used to heat the cabin reduces the range of the BEV.

According to the embodiments described herein, a compressor of a heat pump is controlled using feedforward and feedback control. A feedforward speed is calculated from a heat load that is based on both (a) a current heat transfer to a condenser exchanging heat with air in a cabin of the vehicle and (b) a desired rate of change in temperature, such as in the temperature of air exiting the condenser. Feedback control may be based on feedback error indicating a difference between a target value and a variable. The target value and variable may include the output of any of a number of temperature sensors selected based on a mode of operation of the heat pump, such as temperature of coolant for cooling a battery, temperature of air output of the condenser, or other value.

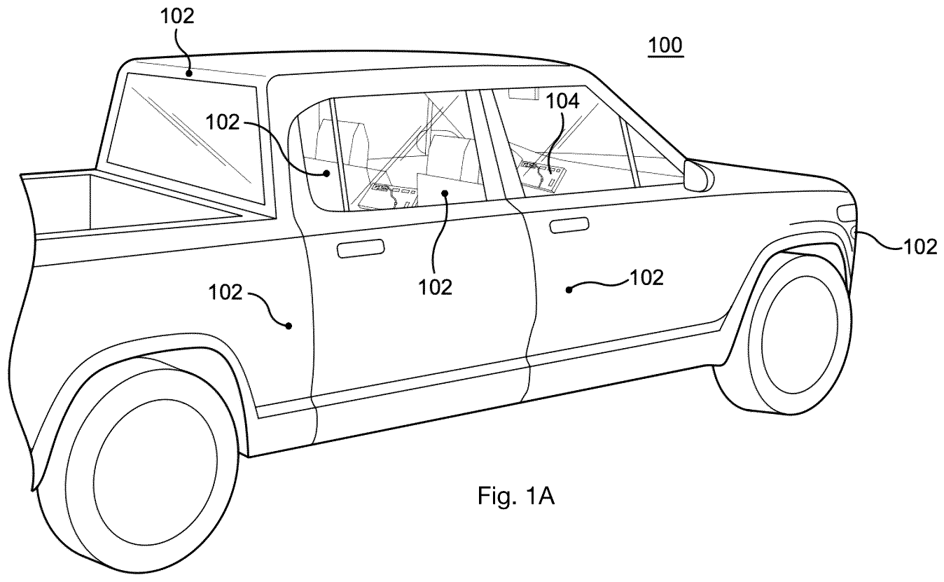

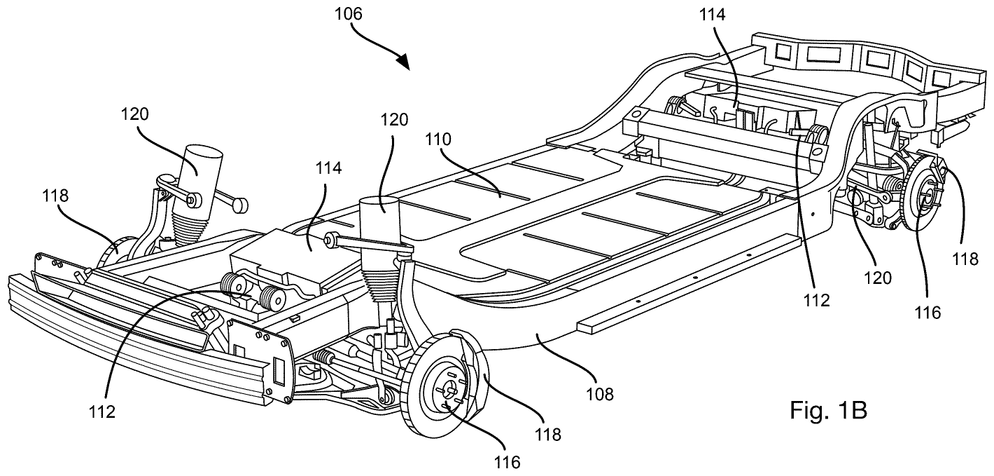

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

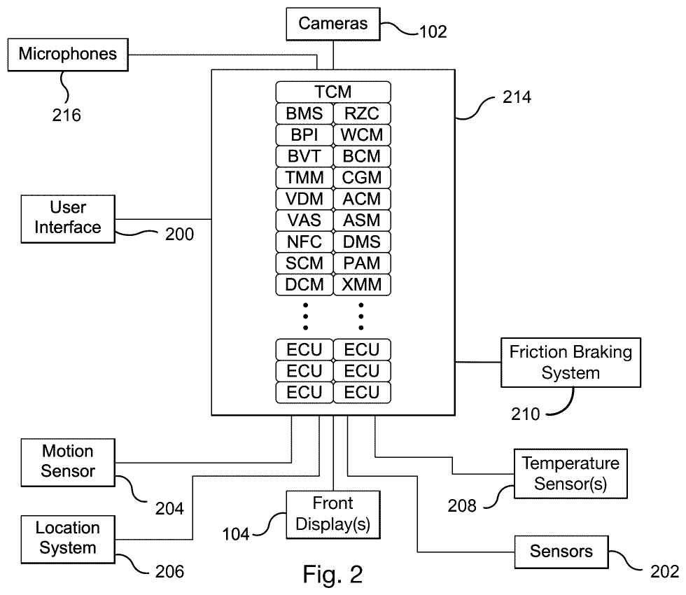

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100.

The components of the vehicle 100 may include a friction braking system 210. The friction braking system 210 may include any components of a hydraulic braking system, such as a rotor, brake pads, calipers, caliper pistons, a master cylinder coupled to the brake pedal and coupled to the caliper pistons by brake lines. The friction braking system 210 may further include a pump and/or valves for automatically applying hydraulic pressure to the caliper pistons. The friction braking system 210 may be implemented as a drum braking system or any friction braking system known in the art.

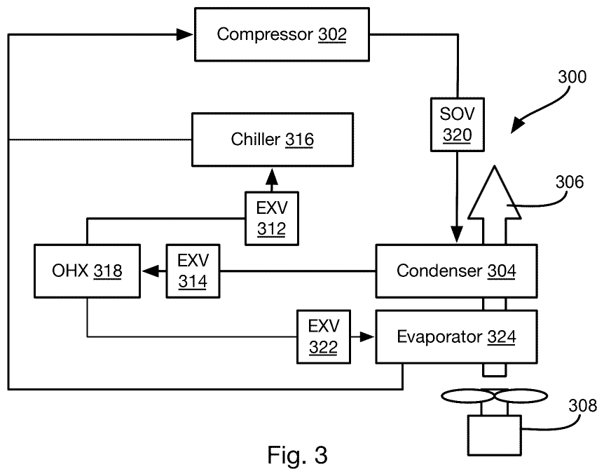

A control system 214 executes instructions to perform at least some of the actions or functions of the vehicle 100, including the functions described in relation to FIGS. 3 to 6. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions. Each ECU may be a computer system and each ECU may include functionality described below in relation to FIGS. 3 to 6.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for performing, for example, the operations and functions described in relation to FIGS. 3 to 11B.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The ECUs may include one or more ECUs that are configured to control the friction braking system 210. For example, the ECUs may include a traction control module, a stability control system, automated emergency braking (AEB) module, anti-lock braking system (ABS), adaptive cruise control module (ACC), and/or an automated driving assistance system (ADAS). The traction control module controls braking and acceleration to control wheel slip according to any approach known in the art. The traction control module may also control the torque applied at each wheel, i.e., torque vectoring. The stability control system controls braking and acceleration in order to avoid rollovers of the vehicle 100 according to any approach known in the art. The AEB module stops the vehicle 100 in a controlled manner response to predicted collisions according to any approach known in the art. The ABS modulates braking to maintain traction. The ACC maintains a speed of the vehicle while also maintaining a prescribed following distance with respect to other vehicles. The ADAS controls steering, acceleration, and braking of the vehicle 100 to arrive at a destination according to any self-driving approach known in the art.

Referring to FIG. 3, a vapor compression heat transfer system 300 (“system 300”) may be used to heat a cabin of the vehicle 100. The system 300 may therefore operate as a heat pump. In the description below, operation of the system 300 as a heat pump is described with the understanding that components of the system 300 may be switched over to function as a refrigeration system for cooling the cabin of the vehicle 100. The illustrated system 300 is exemplary only. Any heat pump system known in the art, particularly those included in vehicles may be used.

The system 300 includes a compressor 302 that compresses a refrigerant within the system 300, such as from a vapor to a liquid, which causes an increase in temperature of the refrigerant. The compressed refrigerant is conducted to a condenser 304. The condenser 304 transfers heat from the compressed refrigerant to the cabin of the vehicle 100. The condenser 304 may be located within the cabin or air flow 306 passing over the condenser 304 may be conducted into the cabin, such as by a fan 308.

The compressed refrigerant exits the condenser 304 and passes through one or more. expansion valves 312, 314. The expansion valves 312, 314 permit the compressed refrigerant to expand and thereby decrease in temperature. The expansion valves 312, 314 may have a range of positions defining the flow of compressed refrigerant through the expansion valves 312, 314. For example, the expansion valves 312, 314 may be implemented as electronic expansion valves (EXV) 312, 314. The expanded refrigerant exiting the EXVs 312, 314 may absorb heat from one or more sources. For example, the expanded refrigerant may pass through a chiller 316. The chiller 316 is a heat exchanger that facilitates the transfer of heat from a coolant of a thermal management system to the expanded refrigerant. The coolant may be circulated by the thermal management system around the battery 110, power electronics 114, and/or drive units 112 of the vehicle 100 to maintain these components in desired ranges.

The expanded refrigerant exiting the expansion valve 314 may pass through an outside heat exchanger 318. The outside heat exchanger 318 facilitates the transfer of heat from the environment of the vehicle 100 into the expanded refrigerant. The outside heat exchanger 318 may therefore be implemented as a radiator including an elongate folded tube with fins. The outside heat exchanger 318 may rely on passive air flow and/or may include a fan to force air flow over the radiator.

In the illustrated embodiment, the chiller 316 and OHX 318 are in series with refrigerant first passing through the OHX 318 followed by passing through the chiller 316. The expansion of the expansion valves 312, 314 may therefore be a partial expansion from the density and phase of the refrigerant at the outlet of the compressor 302 and the density and phase of the refrigerant at the inlet of the compressor 302.

Expanded refrigerant exiting the EXVs 312, 314 may return to the compressor 302. In some embodiments, one or more shut off valves (SOV) 320 may be present in the system 300. The SOV 320 may have open and closed states with any intermediate state being traversed when transitioning between the open and closed states. In the illustrated embodiment, a SOV 320 is present between the outlet of the compressor 302 and the inlet of the condenser 304, but other arrangements are possible.

In some embodiments, the system 300 may simultaneously act as a heat pump and a refrigerator. For example, air circulated through the cabin may be cooled to remove moisture from the air in order to defog windows. Accordingly, an evaporator 324 and corresponding expansion valve 322 supplying expanded refrigerant to the evaporator 324 may also be present. Air flow over the evaporator 324 may be induced by the fan 308 or a separate fan. Expanded refrigerant may be received from a dedicated expansion valve 322 or one of the other EXVs 312, 314. For example, the evaporator 324 may be in series (e.g., upstream) of the OHX 318, and the expansion valve 322 and receive refrigerant that has already passed through the OHX 318. In other embodiments, the evaporator 324 may be in parallel with the OHX 318. Further, in some embodiments, the chiller 316 may be in parallel with the OHX 318 as well.

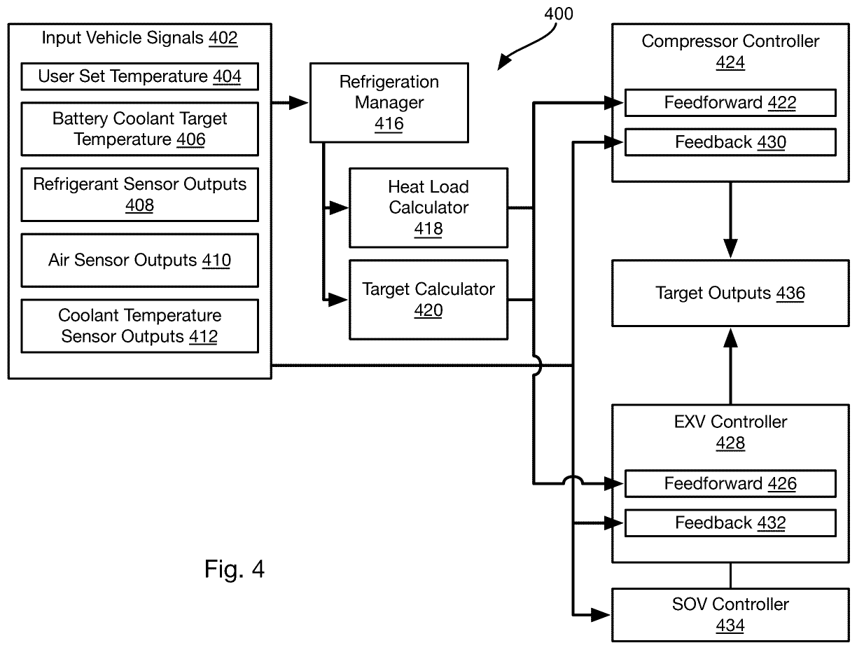

Referring to FIG. 4, a control architecture 400 may be implemented by the control system 214, e.g., a TMM and/or XMM of the control system 214, in order to manage heat flow. into the cabin of the vehicle 100 and control operation of the compressor 302, EXVs 312, 314, and SOV 320. Various descriptions of the control architecture 400 provided herein relate to the compressor 302, EXVs 312, 314, and SOV 320. In some embodiments, however, thermostatic control of the fan 308, any fan incorporated into the OHX 318, and pumps and valves controlling the flow of coolant through the chiller 316 may be controlled by separate algorithms or as part of the control architecture 400.

The control architecture 400 may act in response to input vehicle signals 402. The input vehicle signals 402 may include a user set temperature 404, e.g., a desired cabin temperature specified by an occupant of the cabin through interaction with a control (button or knob) or touch screen. The input vehicle signals 402 may include a target temperature 406 for coolant passing through the chiller 316 (e.g., inlet and/or outlet temperature).

The input vehicle signals 402 may include the refrigerant sensor outputs 408 of one or more refrigerant sensors. The one or more refrigerant sensors may sense the temperature, pressure, and/or flow rate of refrigerant at the inlet and/or output of some or all of the compressor 302, EXVs 312, 314, chiller 316, OHX 318, and evaporator 324.

The input vehicle signals 402 may include the outputs 410 of one or more air sensors. The one or more air sensors may sense the temperature, pressure, and/or flow rate of air flow 306 entering and/or exiting the condenser 304. The air sensors may measure air temperature at the air inlet and the air outlet of the condenser 304. The air sensors may measure the temperature of air exiting one or more vents into the cabin and/or entering one or more return vents from the cabin. The outputs 410 may include temperatures derived from the outputs of one or more temperature sensors. For example, a breath temperature may be defined as an estimate of the temperature of air immediately adjacent an occupant of the vehicle, such as within 5, 10, or 15 centimeters of an occupant of the vehicle. The breath temperature may therefore be the output of a sensor located in a steering wheel, in a head liner above a seat, and/or some other location. The breath temperature may be derived from the output of an infrared sensor or camera.

The input vehicle signals 402 may include the outputs 412 of one or more coolant temperature sensors, such as one or more temperature sensors sensing the temperature of coolant entering at the inlet and/or outlet of the chiller 316.

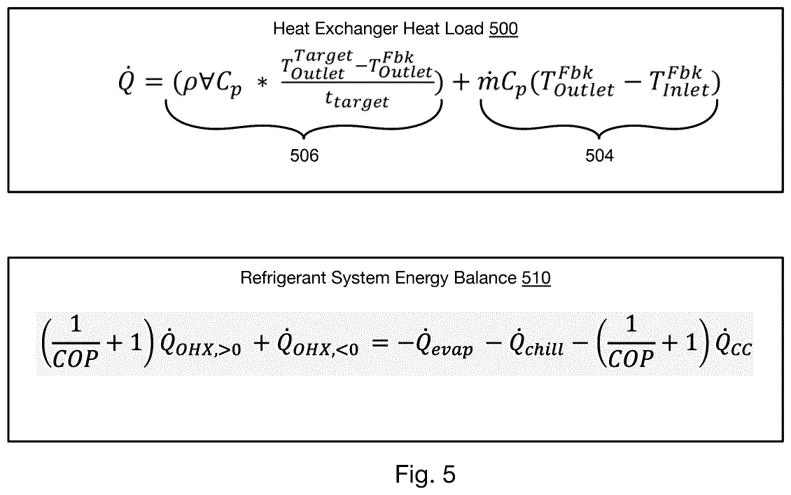

The control architecture 400 may include a refrigeration manager 416. The refrigeration manager 416 may be configured to select temperature sensors to use for performing feedback control of the mass flow rate and/or pressure of refrigerant downstream from the compressor 302. The refrigeration manager 416 may do so using some or all of the input vehicle signals 402. The refrigeration manager 416 may further include a heat load calculator 418 and a target calculator. The heat load calculator 418 estimates a heat load for the cabin and possibly the chiller 316 (see FIG. 5 and corresponding description).

The target calculator 420 calculates target temperatures and pressures for the outputs of some or all of the refrigerant sensor outputs 408. In particular, the target calculator 420 may calculate a target temperature for refrigerant at the outlet of the compressor 302. The target temperature may be a function of the user set temperature 404, e.g., the user set temperature 404 plus a fixed amount or a dynamic amount. The dynamic amount may be a function of variables such as solar loading, ambient temperature, temperature in the cabin, heat load on a chiller 316, or other variable. A target pressure may be calculated based on the target temperature. For example, the target inlet pressure and target outlet pressure may be selected such that the refrigerant will transition from gas to liquid as part of transition to the target temperature, such as according to a phase diagram for the refrigerant as known in the art of thermodynamics and vapor compression heat transfer.

The outputs of the heat load calculator 418 and the target calculator 420 may be provided to a feedforward component 422 of a compressor controller 424. The feedforward component 422 may process the outputs to obtain parameters directly defining operation of the compressor 302, such as a rotational speed (RPM) target for a motor of the compressor 302, or other parameter.

The outputs of the heat load calculator 418 and the target calculator 420 may be provided to a feedforward component 426 of an EXV controller 428. The feedforward component 426 may process the outputs to obtain parameters directly defining operation of one or more of the EXVs 312, 314, 322, such as percentage of an open area of an EXV, e.g., 0% being completely closed and 100% being completely open.

The compressor controller 424 may implement a feedback component 430, and the EXV controller 428 may implement a feedback component 432. The feedback components 430, 432 may output targets for the same parameters as the feedforward components 422, 426, respectively. The feedback components 430, 432 may generate their outputs directly from one or more of the input vehicle signals 402, i.e., without regard to the outputs of the heat load calculator 418 and target calculator 420. The feedback components 430, 432 may compensate for inaccuracy of the feedforward components 422, 426. However, the use of the feedforward components 422, 426 will still enable more rapid achievement of target temperatures than feedback control alone.

In some embodiments, a SOV controller 434 selects one or more parameters controlling operation of the one or more SOV 320, such as whether the SOV 320 should be open or closed. The SOV controller 434 may take some or all of the input vehicle signals 402 as inputs. In some modes of operation, the SOV controller 434 will simply maintain the SOV 320 in an open position absent shutdown or an anomalous condition.

The outputs of the compressor controller 424, EXV controller 428, and SOV controller 434 are target outputs defining the parameters of the compressor 302, EXVs 312, 314, 322, and one or more SOVs 320, respectively. The target outputs 436 may be provided to control circuits, ECUs, or other components that monitor and control the compressor 302, EXVs 312, 314, 322, and one or more SOVs 320 in order to attempt to achieve the target outputs 436.

FIG. 5 illustrates calculations that may be used by the heat load calculator 418 in order to estimate the heat load of the cabin of the vehicle 100. Specifically, the heat load calculator 418 may calculate terms of heat exchanger heat load 500 for some or all components of the system 300 that perform heat exchange, such as the condenser 304, chiller 316, evaporator 324, and the OHX 318. For example, heat exchanger heat load 500 may be used to calculate an estimate of heat load on the refrigerant in the system 300.

The heat load \dot{Q} of a heat exchanger may include two components. One component 504 may be a measured heat flow based on a temperature difference of fluid at the inlet and outlet of the heat exchanger and the mass flow rate of the fluid, i.e., the amount of heat transferred into or out of the refrigerant. A second component 506 may be a target amount of heat flow into the fluid based on a target temperature.

The variables in the equation for the heat exchanger heat load 500 may be defined as follows:
ρ is the density of fluid (air or coolant) flowing over the heat exchanger
∀ is corresponds to the volume of fluid within the heat exchanger.
Cₚ is the specific heat of the fluid.

$${T}_{Outlet}^{Target}$$

is the target temperature of fluid output from the heat exchanger

$${T}_{Outlet}^{F b k}$$

is the measured temperature of fluid output from the heat exchanger

$${T}_{Inlet}^{F b k}$$

is the measured temperature of air input to the heat exchanger
t_{target} is a time constant indicating a desired rate of temperature change
\dot{m} is the mass flow rate of fluid through the heat exchanger

$${T}_{Outlet}^{Target}$$

for the condenser 304 may be calculated by the target calculator 420 and may be a function of the user set temperature 404, e.g., the user set temperature 404 plus a fixed value.

$${T}_{Outlet}^{Target}$$

for the condenser 304 may be calculated as the user set temperature 404 plus a dynamic value that is a function solar loading, ambient temperature, temperature in the cabin, heat load on a chiller 316, or any other attribute of the environment of the vehicle 100 or of the vehicle 100 that affects temperature within the cabin of the vehicle 100. As discussed in greater detail below, the system 300 may be operated in different modes such

$${T}_{Outlet}^{Target}$$

may be calculated differently for different modes.

The illustrated refrigerant system energy balance 510 relates the heat load of the various heat exchangers of the system 300 to one another. The variables of the refrigerant system energy balance 510 may be defined as follows:
COP is the coefficient of performance of a heat exchanger (fixed or dynamic)
\dot{Q}_{OHx,>0} is the heat load of the OHX 318 when absorbing heat from ambient air
\dot{Q}_{OHx,>0} is the heat load of the OHX 318 when emitting heat into ambient air
\dot{Q}_{EVAP} is the heat load of the evaporator 324
\dot{Q}_{chill} is the heat load of the chiller 316
\dot{Q}_{cc} is the heat load of the condenser 304

The overall heat load to be met by the compressor 302 may be the sum of the terms to the right of the equal sign in the refrigerant system energy balance 510. In the subsequent description, \dot{Q} may be understood as the overall heat load.

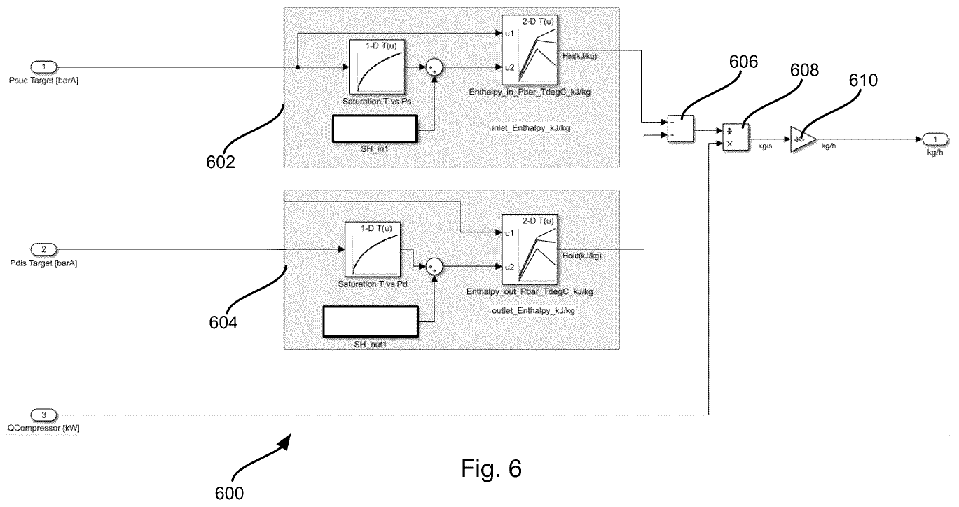

Referring to FIG. 6, once the heat load \dot{Q} is obtained, a mass flow rate of refrigerant may be obtained therefrom according to the control flow 600 of FIG. 6. The illustrated components of the control flow 600 may be implemented by executable code or by discrete electronic components. The control flow 600 may calculate a mass flow rate using \dot{Q}, the target pressure at the inlet of the compressor 302 (P_{suc}), the target pressure at the outlet of the compressor 302 (P_{dis}), and the target temperature at the outlet of the compressor. An inlet enthalpy calculation stage 602 calculates the enthalpy of refrigerant at the inlet based on P_{suc} and the temperature of refrigerant at the inlet. An outlet enthalpy calculation stage 604 calculates the enthalpy of refrigerant at the outlet based on P_{dis} and the target temperature at the outlet. The inlet and outlet enthalpy calculation stages 602, 604 may make use of look up tables and other calculations as known in the art of thermodynamics.

A difference may be calculated at stage 606 between the outlet enthalpy and the inlet enthalpy, and the difference may be divided at stage 608 into the heat load \dot{Q}, which gives a mass flow rate. The mass flow rate may be scaled at stage 610 to obtain a final mass flow rate. For example, stage 610 may convert a mass flow rate from kilograms per second to kilograms per hour.

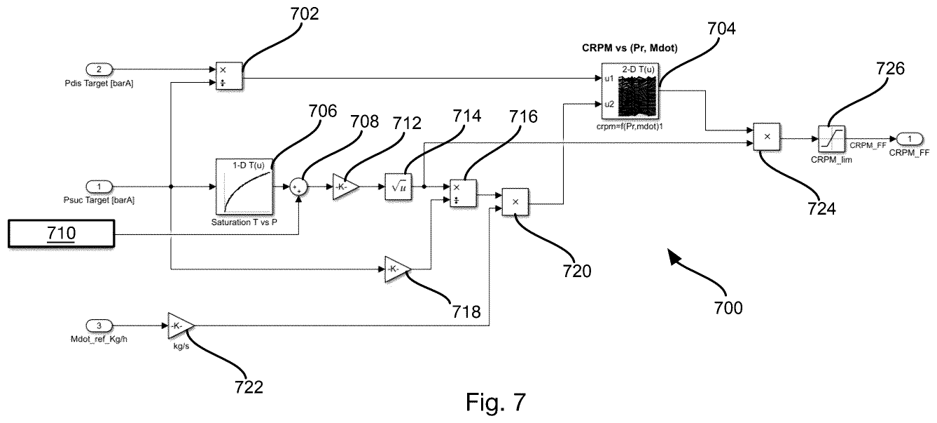

Referring to FIG. 7, once the mass flow rate is obtained, a speed of the compressor may be calculated according to the control flow 600 of FIG. 6. The illustrated components of the control flow 700 may be implemented by executable code or by discrete electronic components.

Stage 702 divides the target outlet pressure (P_{dis}) by the target inlet pressure (P_{suc}). The target outlet pressure (P_{dis}) by the target inlet pressure (P_{suc}). The ratio output by stage 702 and the mass flow rate may be used to select the speed (e.g., revolutions per minute (RPM)) of the compressor 302 directly at stage 704, such as by using a lookup table or other function. However, in the illustrated embodiment, the relationship between the inlet pressure and the mass flow rate may be used to more accurately calculate the speed of the compressor 302.

For example, the target inlet pressure (P_{suc}) may be processed at stage 706 according to a saturation plot (temperature vs pressure) for the refrigerant. The output of stage 706 may be a saturation temperature (e.g., in Kelvin) corresponding to the target inlet pressure (P_{suc}). The saturation temperature and a compensation temperature 710 (e.g., in Kelvin) may be summed at stage 708 and scaled at stage 712. The compensation temperature may be a factor selected to improve the accuracy of the compressor speed calculated using the control flow 700. The compensation temperature may be a fixed value or a function of any of the input vehicle signals, mass flow rate, and or heat load \dot{Q}. The compensation temperature 710 may be selected experimentally, e.g., a value selected based on measurements of mass flow rate through the compressor 302 in order to accurately predict the relationship between mass flow rate and measured values input to the control flow 700.

A square root of the output of the scaling stage 712 may be calculated by stage 714. The output of stage 714 may be divided at stage 716 by a value output by stage 718, the value being the result of scaling the target inlet pressure (P_{suc}). The output of stage 718 may be multiplied at stage 720 by a value output by stage 722, the value being the result of scaling the mass flow rate, such as the mass flow rate determined according to the control flow 600.

The product from stage 720 may be used as a second value along with the target outlet pressure (P_{dis}) to select a compressor speed at stage 704. For example, the product from stage 720 may effectively be a compensated mass flow rate that, along with the pressure different from stage 702 is used to obtain a compressor speed at stage 704. Stage 704 may be a lookup table, curve fit, or other function that provides a compressor speed estimated to achieve the target outlet pressure (P_{dis}) and mass flow rate. Stage 704 may include using data provided by a manufacturer or a compressor 302 relating inlet pressure, outlet pressure, and mass flow rate to compressor speed.

The output of stage 704 may be used to control the speed of the compressor 302 or may be further adjusted by multiplying the output of stage 704 by the output of stage 714 at stage 724. The output of stage 724 may be processed by stage 726, which imposes a limit on the compressor speed. For example, stage 726 may simply reduce the output of stage 724 to a maximum speed when the output of stage 726 is larger than the maximum speed. Stage 726 may also include a limiting function, such as ATAN, that maps outputs of stage 724 to a range of value between 0 and the maximum permitted speed of the compressor 302. The output of stage 726 may then be used as the target speed of the compressor 302. A controller of the compressor 302 or other component may then supply current to the compressor 302 with feedback control to achieve the target speed.

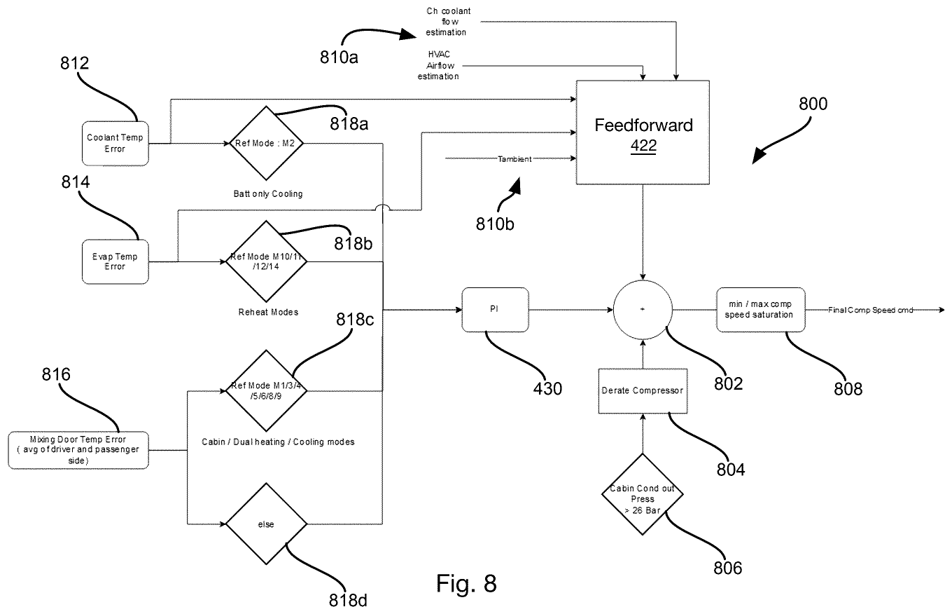

FIG. 8 illustrates a control flow 800 for combining feedforward and feedback control. The control flow 800 may be implemented as part of the control architecture 400. In particular, the outputs of the feedforward component 422 and feedback component 430 may be combined according to the control flow 800.

For example, a summing stage 802 may sum the output of the feedforward component 422 (e.g., a compressor speed according to the control flow 700) with the output of the feedback component 430. The feedback component 430 may output a change increment, indicating a change in speed of the compressor 302 according to variation of a control variable relative to a target for the control variable. The control variable may be any variable affected by operation of the compressor 302. The control variable and/or the target for the control variable may be changed based on one of a plurality of modes that is active. The feedback component may be a proportional-integrator feedback component that produces an output that is a function of an error between the control variable and the target for the control variable as well as an integral of the error over time.

The summing stage 802 may further add an increment determined by a derating stage 804. The derating stage 804 reduces the speed of the compressor 302 according to one or more detected conditions. Whether derating is performed and the amount of the derating may be determined by decision logic 806. The decision logic 806 may invoke derating by the derating stage 804 in response to pressure in the cabin rising above a threshold pressure or some other condition, such as 26 bar. Derating may also be performed based on a temperature (e.g., temperature at input or output of the compressor 302) exceeding a temperature limit.

The output of the summing stage 802 may be input to a saturation stage 808, which outputs a speed target for the compressor 302, which will then be implemented using feedback control by a controller of the compressor 302. The saturation stage may obtain the output thereof by increasing the output of the summing stage 802 if the output of the summing stage 802 is below a minimum speed. The saturation stage may obtain the output thereof by decreasing the output of the summing stage 802 if the output of the summing stage 802 is above a maximum speed. The saturation stage may perform its function by adjustment up or down or by applying a limiting function.

The inputs to the feedforward component 422 may include some or all of the variables 810a relating to mass flow rates used to determine \dot{Q} (see FIG. 5 and corresponding description). For example, the variables 810a may include estimated coolant flow rate (e.g., mass flow rate) for the chiller 316 and mass air flow estimation through the condenser 304 and/or evaporator 324. The inputs to the feedforward component 422 may include some or all of the variables 810b relating to temperature used to determine \dot{Q}, such as an ambient air temperature or the outputs of some or all of the temperature sensors described hereinabove.

The inputs to the feedback component 430 may vary based on which of a plurality of modes is active. For example, FIG. 8 illustrates that the error used by the feedback component 430 may include a coolant temperature error 812, an evaporator temperature error 814, or a cabin temperature error 816. The errors 812, 814, 816 may each be a difference between a sensed temperature at the outlet of the chiller 316, evaporator 324, and condenser 304, respectively, and corresponding target temperature for the sensed temperature. The cabin temperature error 816 may be an average of door temperature sensors, a breath temperature as defined above, a temperature at an air inlet of the condenser 304, or other measure of cabin temperature. Some or all of the errors 812, 814, 816 may also be input to the feedforward component 422, e.g., for use as the

$${T}_{Outlet}^{Target} - {T}_{Outlet}^{TFbk}$$

term of the heat exchanger heat load 500.

Decision blocks 818a-818c may be used to determine which of the errors 812, 814, 816 will be used as the input to the feedback component 430. As shown in FIG. 8, each decision block may evaluate which of a plurality of modes is active. If the mode corresponding to an error 812, 814, 186 is active, then that error 812, 814, 816 will be used as the input to the feedback component 430. For example, mode M2 will invoke use of the coolant temperature error 812 (decision block 818a), modes M10, M11, M12, and M14 will invoke use of the evaporator temperature error 814 (decision block 818b), modes M1, M3, M4, M5, M6, M8, M9 will invoke use of a cabin temperature error 816 (decision block 818c). The cabin temperature error may also be used as the default input (decision block 818d).

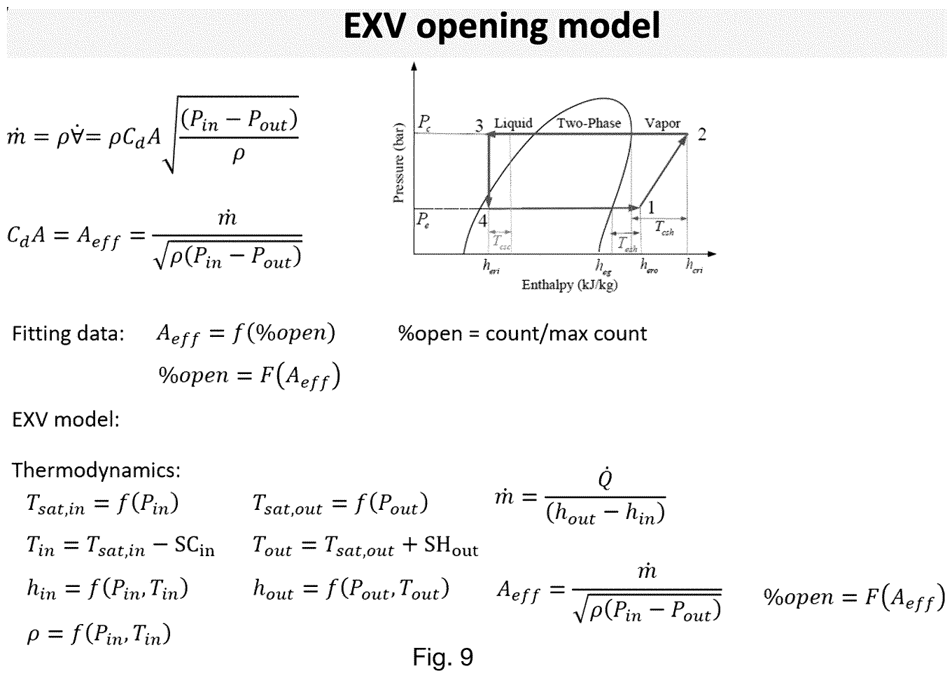

FIG. 9 illustrates equations that may be used to perform feedback control of the degree of opening (“% open”) of an EXV 312, 314, 322. The degree of opening determined according to FIG. 9 may be provided to a controller of the EXV 312, 314, 322, which will then actuate the EXV 312, 314, 322 to achieve the specified degree of opening. The variables of FIG. 9 may be defined as follows:
\dot{m} is the mass flow rate of refrigerant (FIG. 6)
ρ is the density of the refrigerant.
C_{d} is the coefficient of drag of the EXV at a given open percentage
A is the open area of the EXV at a given open percentage.
Pᵢₙ is the inlet pressure of the EXV.
Pₒᵤₜ is the outlet pressure of the EXV.
A_{eff} is a the product of C_{d} and A
f(% open) is a function (e.g., curve fit) that relates Aeff to open percentage.
f(Pᵢₙ) is a function that estimates inlet saturation temperature (T_{sat,in}) based on Pᵢₙ
f(Pₒᵤₜ) is a function that estimates outlet saturation temperature (T_{sat,out}) based on Pₒᵤₜ
f(Pᵢₙ, Tᵢₙ) is a function that estimates input enthalpy (hᵢₙ) for Pᵢₙ and Tᵢₙ
f(Pₒᵤₜ, Tₒᵤₜ) is a function that estimates output enthalpy (hₒᵤₜ) for Pₒᵤₜ and Tₒᵤₜ
ρ=f(Pᵢₙ, Tᵢₙ) is a function that estimates ρ for Pᵢₙ and Tᵢₙ
SCᵢₙ is the point (temperature) on the saturation curve for the refrigerant at Pᵢₙ
SCₒᵤₜ is the point (temperature) on the saturation curve for the refrigerant at Pₒᵤₜ

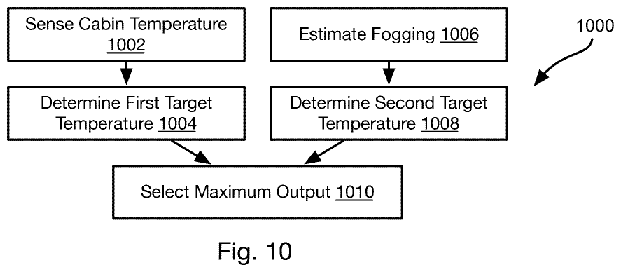

FIG. 10 illustrates a method 1000 that may be executed to select a target temperature, such as the target temperature for air output from the condenser 304 for the control flows discussed above. The method 1000 may be executed by the target calculator 420 or other component of the control system 214.

The method 1000 may include sensing, at step 1002, a cabin temperature. The cabin temperature may be the output of a single cabin temperature sensor, the average of multiple sensors (e.g., average of door sensors), or derived from the output of one or more cabin temperature sensors (e.g., breath temperature). A first target temperature may be determined at step 1004 from the cabin temperature from step 1002. The target temperature may be an amount above the cabin temperature (heating) or below the cabin temperature (cooling). The amount may be fixed or a function of other variables such as solar loading, ambient temperature, temperature in the cabin, heat load on a chiller 316, or other variable.

The method 1000 may include estimating, at step 1006, fogging of one or more windows of the vehicle 100. The fogging may be estimated using the output of one or more humidity sensors sensing humidity in the cabin. The fogging may additionally or alternatively be detected by evaluating images of one or more windows and detecting fogging represented in the windows. Fogging may be detected by detecting conditions that are likely to result in fogging: cold ambient temperature and high humidity in the cabin.

The method 1000 may include determining, at step 1008, a temperature suitable for removing the fogging at an acceptable rate. The relationship between degree of fogging and temperature may be determined from a look up table, function, or other relationship.

The method 1000 may then include selecting, at step 1010, the greater of the temperatures determined at steps 1004 and 1008 as the target temperature.

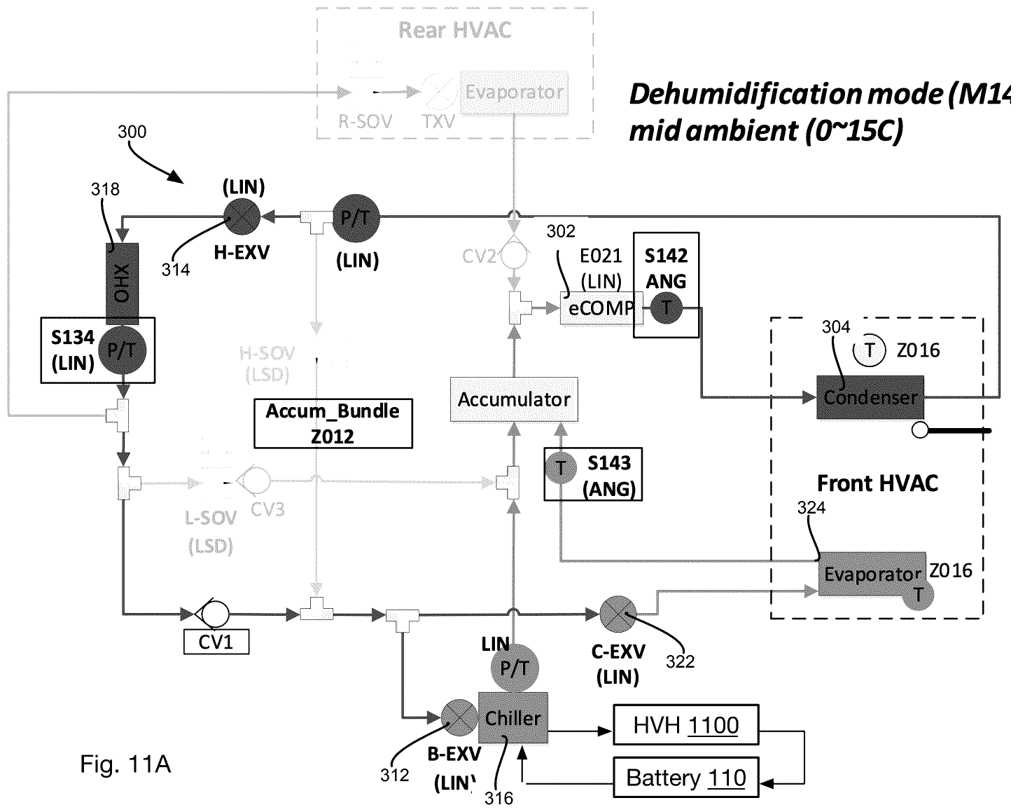

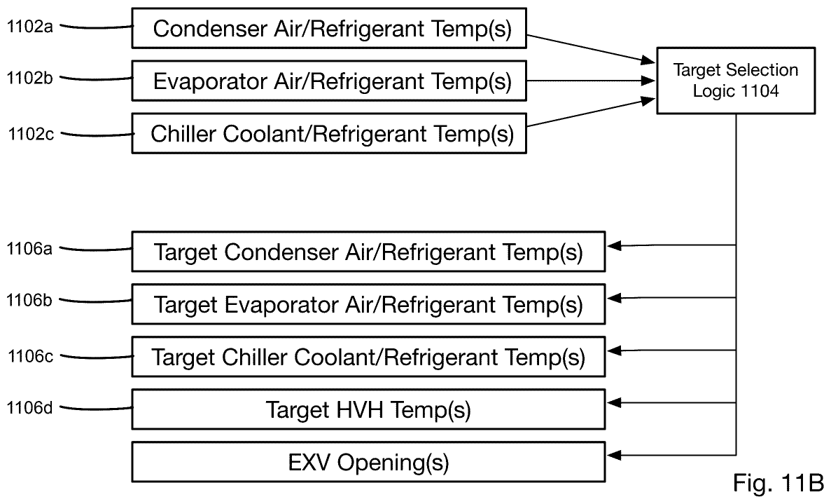

Referring to FIG. 11A, the system 300 may be embodied as illustrated in FIG. 11, with the addition of a heater, such as a high voltage heater (HVH) 1100 that is configured to heat the coolant that passes around the battery 110 and possibly the drive units 112. FIG. 11 further illustrates temperature sensors (“T”) and pressure and temperature sensors (“P/T”) used to sense the temperature of refrigerant exiting components of the system 300.

Referring to FIG. 11B, the system 300 may include target selection logic 1104, such as implemented by the by the control system 214, e.g., a TMM and/or XMM of the control system 214. The target selection logic 1104 may be configured to manage complex interactions among components of the system 300 when both the evaporator 324 and the condenser 304 are in use. For example, both the evaporator 324 and the condenser 304 may be used in a mid-ambient temperature range in which the evaporator 324 is used to perform dehumidification of cabin air while the condenser 304 is simultaneously used to perform heating of cabin air. For example, the mid-ambient temperature range may be between 0 and 30, or between 0 and 15, degrees Celsius.

As shown in FIG. 11B, the target selection logic 1104 may take, as inputs, temperatures 1102a-1102b sensed by the system 300, such as the temperatures 1102a of refrigerant and/or air exiting the condenser 304, the temperatures 1102b of refrigerant and/or air exiting the evaporator 324, the temperatures 1102c of refrigerant and/or coolant exiting the chiller 316. The target selection logic 1104 may select temperature targets for the system 300, such as target temperatures 1106a of refrigerant and/or air exiting the condenser 304, target temperatures 1106b of refrigerant and/or air exiting the evaporator 324, target temperatures 1106c of refrigerant and/or coolant exiting the chiller 316. The target selection logic 1104 may further select a target 1106d for the HVH 1100, such as a target temperature, target output (e.g., Joules), or target input (e.g., Amperes). The target selection logic 1104 may further select a degree of opening of the EXVs 312, 314, 322.

The target selection logic 1104 may select the target temperature for fluid (air or coolant) exiting a component based on the measured temperature of fluid (air or coolant) exiting the component and one or more other components, particularly in the mid-ambient temperature range. The degree of opening of an EXV 312, 314, 322 supplying refrigerant to a component may be opened or closed based on an error between the target temperature and an actual temperature for fluid exiting the component

In one example, the evaporator 324 and the condenser 304 are working against one another in the mid-ambient temperature range with the evaporator 324 cooling the air 306 and the condenser 304 heating the air output from the evaporator 324. Accordingly, a command to increase compressor speed and mass flow rate of refrigerant in order to achieve a target discharge air temperature from the condenser 304 will also increase the flow rate of refrigerant through the evaporator 324, which may cause freezing of water vapor in the evaporator 324. Separate targeting of the discharge temperatures of the evaporator 324 and the condenser 304 may result in one of the target discharge temperatures failing to be met.

Accordingly, the target selection logic 1104 may perform compensating actions when freezing of the evaporator 324 is deemed likely or when simultaneous achievement of target temperatures of the evaporator 324 and the condenser 304 would otherwise not be achieved. Freezing of the evaporator 324 may be deemed likely when (a) a temperature of air output from the evaporator 324 falls below a threshold (e.g., 2, 1, 0.5, or 0 degrees Celsius), (b) a flow rate of refrigerant rises above a threshold flow rate, and/or (c) a combination of factors relating to inlet and outlet air temperatures, inlet and outlet refrigerant temperatures, and mass flow rate of refrigerant through the evaporator 324, and degree of opening of the EXV 322 indicate freezing may be likely.

Compensating actions may include redirecting a greater amount of refrigerant though the chiller 316, e.g., greater than required to maintain the battery 110 in a desired operating range based on an error between an actual temperature and a target temperature for air output from the evaporator 324. For example, the EXV 312 may be opened or a temperature target for the coolant exiting the chiller 316 may be dropped. Directing a greater amount of refrigerant to the chiller 316 may be beneficial due to (a) increased heat from the battery 110 being drawn into the refrigerant and raising the overall temperature of refrigerant in the system 300 and (b) increasing the pressure at the outlet of the evaporator 324 due to the evaporator 324 and chiller 316 being in parallel, which will reduce the flow of refrigerant through the evaporator 324.

In the event that the temperature of the battery 110, or of the coolant, falls below a battery temperature threshold while a compensating action is being performed, the HVH 1100 may be activated to raise the temperature of the coolant and the corresponding temperature of the battery 110 to above the battery temperature threshold.

In another example, the OHX 318 may be operated as an evaporator or a condenser based on the reheat load of the condenser 304, e.g., the reheating required to reverse cooling by the evaporator 324. For example, where the condenser 304 is unable to achieve a target temperature for the air flow 306 exiting the condenser 304, the OHX 318 may be caused to function as an evaporator in order to draw heat from ambient air and raise the enthalpy of refrigerant within the system 300.

The above example is a single example of how the interaction among the components of the system 300 may be used to select the temperature targets for components of the system 300 and degree of opening for expansion valves 312, 314, 322. In general, control of the expansion valves 312, 314, 322, the HVH 1100, and compressor 302 may be coordinated to achieve dual temperature targets of the evaporator 324 and condenser 304 in order to achieve dehumidification and heating.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A vapor compression heat transfer system comprising:
a compressor configured to compress a refrigerant;
a condenser coupled to an outlet of the compressor and configured to receive air flow from a space, the condenser including an inlet air temperature sensor and an outlet air temperature sensor;
one or more valves coupled to the outlet of the condenser;
one or more heat exchangers coupled to outlets of the one or more valves; and
a controller coupled to the compressor, the one or more valves, the inlet air temperature sensor, and the outlet air temperature sensor, the controller configured to:
determine a heat load of the condenser according to: (a) a current heat transfer from the condenser to the space and (b) an amount of heat transfer determined to change an output of the outlet air temperature sensor to a target air temperature at a target rate; and
at least partially control a speed of the compressor to achieve the heat load at the condenser.

2. The vapor compression heat transfer system of claim 1, wherein the target air temperature is a function of a target space temperature for air in the space.

3. The vapor compression heat transfer system of claim 1, wherein the space is a cabin of a vehicle.

4. The vapor compression heat transfer system of claim 3, wherein the one or more heat exchangers include an outside heat exchanger configured to exchange heat with an environment outside of the vehicle.

5. The vapor compression heat transfer system of claim 3, wherein the one or more heat exchangers include a chiller configured to exchange heat with coolant circulating to one or more components of the vehicle.

6. The vapor compression heat transfer system of claim 5, wherein the vehicle is a battery electric vehicle, and the one or more components include a battery.

7. The vapor compression heat transfer system of claim 1, wherein the controller is further configured to control the speed of the compressor according to both the heat load and a feedback error.

8. The vapor compression heat transfer system of claim 7, wherein the controller is further configured to control the speed of the compressor according to both the heat load and an output of a proportional-integrator feedback component based on the feedback error.

9. The vapor compression heat transfer system of claim 7, wherein the feedback error is based on a difference between a target value and an output of a selected temperature sensor, the selected temperature sensor being one of the outlet air temperature sensor, a cabin temperature sensor configured to sense a temperature of the space, and a heat exchanger temperature sensor configure to sense a temperature of coolant flowing through a heat exchanger of the one or more heat exchangers.

10. The vapor compression heat transfer system of claim 9, wherein the controller is further configured to select the selected temperature sensor according to an ambient temperature surrounding the space and a target space temperature for air in the space, the target air temperature being a function of the target space temperature.

11. The vapor compression heat transfer system of claim 1, wherein the controller is further configured to:
calculate a mass flow rate according to the heat load; and
calculate the speed of the compressor according to the mass flow rate.

12. The vapor compression heat transfer system of claim 11, wherein the controller is further configured to control a degree of opening of the one or more valves according to the mass flow rate.

13. The vapor compression heat transfer system of claim 1, wherein the controller is further configured to:
detect fogging of windows defining the space; and
select a target space temperature according to the fogging, the target air temperature being a function of the target space temperature.

14. The vapor compression heat transfer system of claim 1, wherein the controller is further configured to:
receive a first target space temperature for air in the space;
detect fogging of windows defining the space; and
select a second target space temperature according to the fogging, the target air temperature being a function of a larger of the first target space temperature and the second target space temperature.

15. A method comprising:
receiving, by a controller of a vapor compression heat transfer system, a target temperature;
receiving, by the controller, an inlet temperature from an inlet air temperature sensor configured to sense a temperature at an air inlet of a condenser configured to exchange heat with air within a space;
receiving, by the controller, an outlet temperature from an outlet air temperature sensor configured to sense a temperature at an air outlet of the condenser;
determining, by the controller, a heat load based on: (a) a current heat flow out of the condenser according to the inlet temperature and the outlet temperature and (b) a heat flow that raises the outlet temperature to the target temperature at a predefined rate;
selecting, by the controller, a speed of a compressor according to the heat load, an output of the compressor being coupled to a refrigerant inlet of the condenser, an inlet of the compressor being coupled to a heat exchanger, and the heat exchanger being coupled to a refrigerant outlet of the condenser by an expansion valve; and
invoking, by the controller, operation of the compressor to compress refrigerant at the selected speed.

16. The method of claim 15, wherein the target temperature is a function of a target space temperature for air in the space.

17. The method of claim 15, wherein the space is a cabin of a vehicle.

18. The method of claim 15, further comprising selecting, by the controller, the selected speed of the compressor according to both the heat load and a feedback error.

19. The method of claim 18, further comprising selecting, by the controller, the selected speed of the compressor according to both the heat load an output of a proportional-integrator feedback component based on the feedback error.

20. The method of claim 18, wherein the feedback error is based on a difference between a target value and an output of a selected temperature sensor, the selected temperature sensor being one of the outlet air temperature sensor, a cabin temperature sensor configured to sense a temperature of the space, and a heat exchanger temperature sensor configure to sense a temperature of coolant flowing through the heat exchanger.
